(19) United States
(12) Patent Application Publication
(10) Pub. No.: US 2023/0089476 A1
(43) Pub. Date: Mar. 23, 2023

(54) Cell Complex Neural Networks for 3D Object Recognition and Segmentation from Point Cloud Data

(71) Applicants: Santa Clara University, Santa Clara, CA (US); University of South Florida, Tampa, FL (US)

(72) Inventors: Mustafa Hajij, Santa Clara, CA (US); Ghada Alzamzmi, Rockville, MD (US)

(21) Appl. No.: 17/950,850

(22) Filed: Sep. 22, 2022

Related U.S. Application Data
(60) Provisional application No. 63/247,063, filed on Sep. 22, 2021.

(51) Int. Cl. G06V 10/82; G06V 20/58; G06T 7/521; G06T 7/11

(52) U.S. Cl. CPC G06V 10/82; G06V 20/58; G06T 7/521; G06T 7/11; G06T 2207/10028

(57) ABSTRACT

A method for object recognition from point cloud data acquires irregular point cloud data using a 3D data acquisition device, constructs a nearest neighbor graph from the point cloud data, constructs a cell complex from the nearest neighbor graph, and processes the cell complex by a cell complex neural network (CXN) to produce a point cloud segmentation or a point cloud classification using geometric message passing schemes to implement deep learning protocol in the CXN. The point cloud segmentation may include an object classification label for each point in the point cloud, and/or a classification label identifying an object in the point cloud.

### CROSS-REFERENCE TO RELATED APPLICATIONS

This application claims priority from U.S. Provisional Patent Application 63/247,063 filed Sep. 22, 2021, which is incorporated herein by reference.

### FIELD OF THE INVENTION

This invention relates generally to methods and devices for recognition of patterns and objects from 3D point cloud data. More specifically, it relates to machine learning-based algorithms for point cloud recognition.

### BACKGROUND OF THE INVENTION

### 3D Scanner and Point Cloud Recognition Background

There is a vast array of devices today that use some sort of 3D acquisition device and collect a point cloud data. This includes but not limited to modern autonomous vehicles/drones, smart phones, surveillance cameras, and robots. All these devices have some type of 3D acquisition device such as LiDAR-scanners to acquire knowledge about the geometry of the surrounding environment, perform object recognition which ultimately aid the decision making that these vehicles have to make. The collected data from these devices is usually referred to as point cloud. Point cloud are the points that are sampled from the surface of the subject of interest. 3D acquisition devices share multiple traits with cameras in that they have a field of view and they can only collect information about the objects that are not occluded. While a camera can collect colors of the surface, a 3D scanner collects geometric information such as the position of the sampled points and the surface normals. Typically, after the acquisition phase, the point cloud data is processed by a sequence of algorithms in an attempt to recognize objects in the data. The accurate and fast recognition is crucial in most applications related to point cloud recognition. For instance, it is important for an autonomous vehicle or drone to navigate the environment effectively and safely and in a large scale. Similar concerns applies as well to security and surveillance cameras where accurate prediction is crucial for safety and property protection.

Mathematically, 3D scanner data is a point cloud ( [symbol] ) in some Euclidean space. Specifically, each point p in [symbol] is represented by a tuple of the features captured by the scanner. Depending on the scanner utilized to capture the environment, these features typically include the coordinate position of the point, the RGB color, the surface normal along with several other features. Pattern recognition on point cloud is very challenging due to many factors. For example, point clouds are merely a collection of points with no topological information stored, making it very difficult to capture the geometry of the scanned object.

### Challenge of 3D Data Recognition

Algorithms that handle 3D point cloud data recognition are divided into two categories: handcrafted-based algorithms and machine learning-based algorithms. In what follows, we give an overview of these methods and we list their advantages and disadvantages and current challenges in 3D data recognition.

### Handcrafted-Based Algorithms:

These algorithms rely on designing a descriptor (created by human experts) to capture global or local information about the geometric object. For example, Han et al. (3D point cloud descriptors in hand-crafted and deep learning age: State-of-the-art, arXiv preprint arXiv:1802.02297 (2018)) provides a recent survey on point cloud descriptors utilized in the context of point cloud segmentation and recognition. A common drawback across these methods is that they are often designed for a rather specific application and they often fail to generalize beyond simple study cases.

### Machine Learning-Based Algorithms:

Machine learning algorithms usually require regular data input and point clouds are fundamentally irregular from the perspective that a permutation of these points does not change their positional distribution. We refer the reader to machine learning-based algorithms for point cloud recognition (Guo et al., Deep learning for 3D point clouds: A survey, IEEE transactions on pattern analysis and machine intelligence (2020)).

The current state-of-the-art in point cloud recognition relies mainly on graph neural networks (GNNs) technology. One of the main issues with GNNs is the message passing scheme, which has been proven to have limited expressive power capabilities. The expressive power of a graph neural network is a theoretical measure for its capacity to perform recognition tasks across different objects in practice. Networks with less expressive power are incapable of distinguishing between objects that are different. The expressive power of a given network is usually measured by the Weisfeiler Lehman (WL) graph isomorphism test and its hierarchical version k-WL test. These tests basically form a sequence of increasingly more discriminative tests such that the (k+1)-WL provides strictly a more discriminative powerful test than the k-WL test for all k≥1. In other words, higher order tests have the ability to distinguish between larger set graphs. The message passing graph neural networks have been proven to be as powerful as the WL test. In this context, Wang et al. (Dynamic graph cnn for learning on point clouds, Acm Transactions On Graphics (tog) 38 (2019), no. 5, 1-12) proposed a method that utilizes graph neural networks that do not pass the 1-WL test. Recently, Xu et al. (How powerful are graph neural networks?, arXiv preprint arXiv:1810.00826 (2018)) proposed an architecture that can be as expressive as the k-WL test for any k. However, their work suffers from very high computational and memory complexity, making it impractical to implement in practice.

### BRIEF SUMMARY OF THE INVENTION

Herein is described the construction of a new technology that can be utilized for the recognition of patterns and objects obtained from 3D data acquisition devices. The present technology utilizes a recently developed deep learning technology called cell complex neural networks to segment and classify point cloud data gathered from a 3D data acquisition device. These acquisition devices, such as LiDAR scanners, are typically found in modern autonomous vehicles, smart phones, neuroimages, photogrammetry softwares, and security and surveillance cameras. The present technology is applicable to all domains where segmentation and recognition of point cloud data is crucial. This includes but not limited to: geodesy, geomatics, archaeology, geography, geology, geomorphology, seismology, forestry, atmospheric physics, autonomous vehicles/drones, security cameras, surveillance cameras, neuroimages and photogrammetry software.

CXNs (present technology) provides a novel solution for effectively segmenting and recognizing point cloud data obtained from 3D acquisition devices (e.g., LiDAR scanners). These tasks (segmentation and recognition) are crucial in modern autonomous vehicles/drones, smart phones, and surveillance cameras in order to make accurate decisions and predictions. The present technology outperforms existing technologies in terms of performance, computational efficiency and generalizability. The higher accuracy of CXNs is achieved as a result of novel deep learning protocols that utilizes higher order interactions. The feature (higher order interactions) is one of the main features that characterizes our novel technology. Furthermore, modeling higher order interactions provides CXNs with higher generalizability power as compared to existing technologies. In practice, this translates to more accurate and robust prediction capacity across objects with complex geometries and interactions. As for the computational efficiency, CXNs can be modeled and computed using sparse matrices, which are highly efficient to compute and store making them practical for use on devices with low computational power such as smart phones, security and surveillance cameras and autonomous vehicles. Finally, CXNs do not require regular data (i.e., input and point clouds) contrary to existing technologies that can not handle irregular data. We define regular data as the data with a predefined size and are evenly sampled in a grid fashion over the domain of interest. Images are example of regular data. On the other hand, irregular data do not have fixed size or fixed order, and they are not evenly sampled across the domain of interest. Point cloud data is example of irregular data. All these features make CXNs (present technology) an ideal technology for segmenting and recognizing 3D point cloud data obtained from 3D acquisition devices.

Our main contributions can be summarized as follows:

We use a recently developed technology, called cell complex networks (CXNs), for segmenting and recognizing 3D point cloud data obtained from 3D acquisition devices. The present technology offers several advantages making it superior to existing methods (e.g., graph-based and handcrafted algorithms).
1. Higher accuracy: CXNs (present technology) has been proven theoretically to be more expressive than all existing message passing graph neural networks making them suitable to handle the complexity that occurs with complex point cloud data and provide more accurate object recognition.
2. Computational efficiency: CXNs (present technology) only utilizes the local information when performing the computations, making them more efficient from practical and implementation standpoints.
3. CXN is a machine learning method that does not require regular data input and can directly handle the irregular nature of point cloud data. It has been proven theoretically that CXNs is more expressive than all existing graph neural networks making them suitable to handle the complexity of various geometric objects in the present application.
4. CXNs can model higher order interactions, which has been proven to provide higher generalizability; i.e., CXN can generalize on unseen objects that the network did not observe during training making them more useful in practical scenarios.

In one aspect, the invention provides a method for object recognition from point cloud data, the method comprising: acquiring point cloud data using a 3D data acquisition device, wherein the point cloud data is irregular data (where irregular data is data that does not have a predefined size or uniform sampling); constructing a nearest neighbor graph from the point cloud data; constructing a cell complex from the nearest neighbor graph, wherein the cell complex includes k-cells, where k>2; and processing the cell complex by a cell complex neural network (CXN) to produce a point cloud segmentation or a point cloud classification, wherein the CXN includes k-cells, where k>2, and wherein the processing by the CXN comprises using geometric message passing schemes to implement deep learning protocol in the CXN.

In one implementation, the point cloud segmentation comprises an object classification label for each point in the point cloud. Alternatively, the point cloud classification comprises a classification label identifying an object in the point cloud.

In one implementation, the 3D data acquisition device is a LiDAR scanner. Preferably, constructing the cell complex comprises constructing a clique complex. Preferably, the message passing schemes include adjacency message passing schemes, co-adjacency message passing schemes, or homology and co-homology message passing schemes. Preferably, the CXN is modeled and computed using sparse matrices.

### BRIEF DESCRIPTION OF THE SEVERAL VIEWS OF THE DRAWINGS

FIG. 1A and FIG. 1B are processing pipelines for recognition of 3D data obtained from a 3D acquisition device, showing a scene segmentation mode and an object recognition mode, respectively, according to embodiments of the invention.

FIG. 2A, FIG. 2B, and FIG. 2C are diagrams illustrating, respectively, an example point cloud, the corresponding k-NN graph obtained from the point cloud, and the corresponding clique complex constructed from the k-NN graph, according to an embodiment of the invention.

FIG. 3 is a diagram illustrating the architecture of a point cloud cell complex network (PCXN), according to an embodiment of the invention.

FIG. 4 is a diagram illustrating the architecture of a point cloud segmentation network, according to an embodiment of the invention.

FIG. 5 is a diagram illustrating the architecture of a point cloud classifications network, according to an embodiment of the invention.

FIG. 6 is a diagram illustrating an overview of a processing pipeline for training and deployment of the present technology, according to an embodiment of the invention.

### DETAILED DESCRIPTION OF THE INVENTION

### Overview of CXN for 3D Data Recognition in Autonomous Vehicle

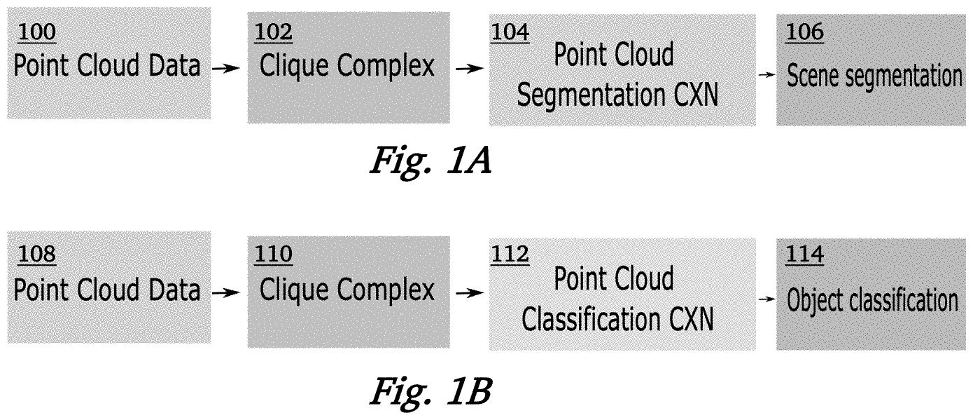

The recognition of 3D data obtained from a 3D acquisition device using the present technology (CXNs) has three main stages, as outlined in FIG. 1A and FIG. 1B, which show processing pipelines for the scene segmentation mode and the object recognition mode, respectively. The first two stages of these are common, and they differ in their last two stages.

In the first stage 100, 108, a 3D scanner collects the point cloud data from the object of interest. In one embodiment, this can be a LiDAR scanner attached to an autonomous vehicle, a scanner attached to smart phone, or a surveillance camera. Mathematically, this data is a collection of points, denoted by [symbol] ={x₁, . . . , xₙ}⊂ [symbol] ^{F} that the scanner device collects from the surrounding environment. This stage is considered a pre-processing stage.

The second stage 102, 110, can also be considered a pre-processing computational stage. In this stage, a cell complex, which we will denote by X= [symbol] ₖ( [symbol] ) is constructed using the k-nearest neighbor graph [symbol] ( [symbol] ) of the point cloud [symbol] .

In the third stage 104, 112, either of two versions of the CXN networks may be used on the complex X to perform the recognition task. The present device has two modes: a segmentation mode shown in FIG. 1A and object recognition mode shown in FIG. 1B. In step 106 of the segmentation mode, each point in the input point cloud scene is classified into one of predefined category labels. The labels effectively provide a recognition for objects in the point cloud set. On the other hand, in step 114 of the object recognition mode, the device is presented with a set of a point cloud, and it outputs the category of this object from a set of predefined categories. We explain the steps of these processing pipelines in more detail below.

### Constructing K-NN Graph and the Clique Complex of the 3D Scanner Data

As we mentioned earlier, a 3D acquisition device scans the surrounding environment and provides us with data which consists of a list of points [symbol] ={p₁, . . . ,pₙ}⊂ [symbol] ^{F}. In the simplest case, each point pϵ [symbol] stores the 3D positional coordinates of the point. Some 3D scanners might also include other information such as the color and the surface normal of the points. The present method (CXN) is robust for all architectural design choices and we shall assume this generality in our discussion below.

Given the collection of points [symbol] , in the second step 102, 110 we first construct k-nearest neighbor (k-NN) graph of [symbol] in [symbol] ^{F} which we will denote by [symbol] ₖ( [symbol] ). The node set is the exact points in [symbol] . The edges connected to a point pϵ [symbol] correspond to k-nearest points qⱼϵ [symbol] to the point p. Multiple packages can be utilized for the computation of the k-NN graph such as the scikit-learn (Pedregosa et al., Scikit-learn: Machine learning in Python, Journal of Machine Learning Research 12 (2011), 2825-2830).

Constructing the Clique Complex from the Point Cloud

Having the k-NN graph [symbol] ₖ(P) steps 102, 110 convert this graph to a complex. This complex will be the input for our custom cell complex networks (CXN). The complex that we will consider is called the clique complex of the graph [symbol] ₖ( [symbol] ). The clique complex of a graph G is a simplicial complex obtained by considering the cliques of G. We denote the clique complex obtained from [symbol] ₖ( [symbol] ) by X= [symbol] ₖ( [symbol] ).

For our purpose we only consider the 2-clique complex associated with the graph [symbol] ₖ( [symbol] ). Thus the complex X= [symbol] ₖ( [symbol] ) will be a 2-dimensional simplicial complex. Next, we store the information collected from the 3D scanner on vertices, the edges and the faces of X as follows. On the vertices of X we store the positional information of the input point cloud. On every edge in X we store the distance between the two nodes that form it. We can also store the color information of the two points by taking the average of the two node's colors that make that edge. Finally, for every face in X we store the average of the normals of the three points that make that face. We denote by H₀⁰, H₀¹, H₀² to the data stored on the nodes, the edges, and the faces of X respectively.

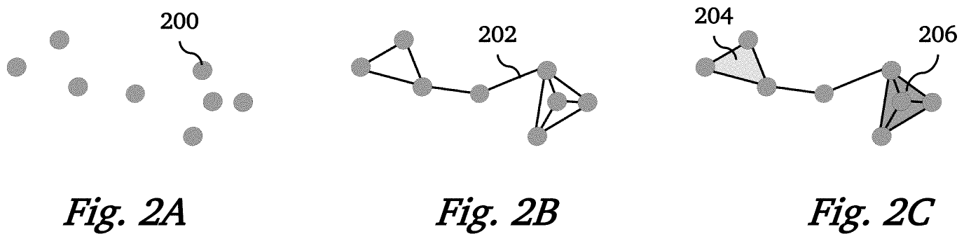

The steps 102, 110 that we described here, going from the point cloud [symbol] to the k-NN graph [symbol] ₖ( [symbol] ) and then finally to the clique complex are further described in relation to FIG. 2A, FIG. 2B, FIG. 2C.

FIG. 2A is a schematic diagram illustrating an example input point cloud [symbol] containing a collection of points, such as point 200. FIG. 2B is a schematic diagram illustrating the k-NN graph [symbol] ₖ( [symbol] ) obtained from the point cloud, showing points connected by edges, such as edge 202. In this example k=2. FIG. 2C is a schematic diagram illustrating the clique complex of X=Cₖ( [symbol] ) constructed from the k-NN graph of FIG. 2B, showing examples of a 2-cell 204 and 3-cell 206.

### Cell Complex Neural Network Implementation

In this section, we introduce the detailed implementation and mathematical background for a cell complex network (CXN) described in Hajij et al. (Cell complex neural networks, NeurIPS 2020 Workshop TDA and Beyond (2020)). For completeness, we also provide a background of multilayer perceptrons (MLPs), which are considered the building block in our construction as described in the section below.

### Multilayer Perceptron

A Multilayer Perceptron is a function Net: [symbol] ^{d}^{ᵢₙ}→ [symbol] ^{d}^{ₒᵤₜ} defined by a composition of the form:

Net:=f_{L}∘ . . . ∘f₁ (1)

where the functions fᵢ, 1≤i≤L called the a dense layer. A layer function fᵢ: [symbol] ⁿ^{ᵢ}→ [symbol] ^{m}^{ᵢ} is typically a continuous, a piecewise smooth or a smooth function of the following form: fᵢ(x)=σ(Wᵢ(x)+bᵢ) where Wᵢ is an mᵢ×nᵢ matrix, bᵢ is a vector in [symbol] ^{m}^{ᵢ}, and σ: [symbol] → [symbol] is an appropriately chosen nonlinear function that is applied coordinate-wise on an input vector (z₁, . . . , zₘ_{ᵢ}) to get a vector (σ(z₁), . . . , σ(zₘ_{ᵢ})). Multilayer perceptrons are implemented in all modern deep learning packages such as TensorFlow (Abadi et al., TensorFlow: Large-scale machine learning on heterogeneous systems, 2015. Software available from tensorflow.org) and Pytorch (Paszke et al., Pytorch: An imperative style, high-performance deep learning library, Advances in neural information processing systems 32 (2019), 8026-8037).

### Cell Complexes

A cell complex is a construct that is built from primitive objects called cells. The 0-cells in a cell complex represent the most primitive entities. Among the 0-cells we define higher dimensional relations, or k-cells.

For our purpose, these k-cells represent a higher order relationship between the 0-cells. In other words, they represent the local relationship between the points in the input point cloud dataset.

To explain cell complex networks computationally we need some notations. For a cell c^{m} of dimension m in a cell complex X, we will denote its adjacent cells of dimension m by [symbol] (c^{m}). We denote the cells in X that are larger than a certain dimension k by X^{>k}. We define X^{<k} similarly. Two cells in X are said to be adjacent if they are both a boundary of a higher dimensional cell in X.

### Geometric Message Passing Schemes Models on Cell Complex

Message passing schemes on graphs leverage the local graph relational structure to obtain a deep learning computational mechanism on these domains. As cell complexes generalize graphs by modeling higher-order interactions between entities, they naturally admit multiple message passing schemes. We introduce a message passing scheme that generalizes the one defined on graphs in Gilmer et al. (Neural message passing for quantum chemistry, International conference on machine learning, 2017, pp. 1263-1272), and two additional new schemes. These schemes were introduced by in Hajij et al. (Cell complex neural networks, NeurIPS 2020 Workshop TDA and Beyond (2020)). Collectively, these schemes form the main computational blocks of the cell complex nets.

### Adjacency Message Passing Scheme (AMPS):

Let X be a cell complex of dimension n. The inputs to this scheme are the initial cell features on every m-cell in X, denoted Hₘ⁽⁰⁾ϵ [symbol] ^{|X}^{^{m}}^{|×d}^{₀}, where d₀ is the input feature dimension. Given the desired depth L>0 of the CXN, the adjacency message passing scheme (AMPS) on X consists of L×n inter-cellular messages and it is defined by

Hₘ^{(k)}:=M(A_{adj},Hₘ^{(k-1)},Hₘ₊₁^{(k-1)};θₘ^{(k)}), (2)

where 0≤m≤n−1, 1≤k≤L, Hₘ^{(k)}ϵ [symbol] ^{|X}^{^{m}}^{|×d}^{ₖ} are the cell features computed after k steps of (Eq. 2), and θₘ^{(k)} is a trainable weight vector at the layer k, and M is the message propagation function that depends on: the weights θₘ^{(k)}, the cell features Hₘ^{(k)}, and A_{adj} the adjacency matrix of X.
Co-adjacency Message Passing Scheme (CMPS): CMPS leverages the co-adjacency relations, in contrast to the adjacency relations utilized in AMPS (Eq. 2). Specifically, let Hₘ⁽⁰⁾ϵ [symbol] ^{|X}^{^{m}}^{|×d}^{₀} be the initial cell feature on every m-cell in X. Given the desired depth L>0 of the CXN, the Coadjacency Message Passing Scheme (CMPS) on X consists of L×n inter-cellular messages and it is defined by

Hₙ₋ₘ^{(k)}:=M(A_{co},Hₙ₋ₘ^{(k-1)},Hₙ₋ₘ^{(k-1)},Hₙ₋ₘ₋₁^{(k-1)},θn−m^{(k)}), (3)

where 0≤m≤n−1, 1≤k≤L, Hₙ₋ₘ^{(k)}ϵ [symbol] ^{|X}^{^{n−m}}^{|×d}^{ₖ} are the cell features computed after k steps of (Eq. 3), θₙ₋ₘ^{(k)} is a trainable weight vector at the layer k, M is the message propagation function that depends on: the weights θₙ₋ₘ^{(k)}, the cell features Hₙ₋ₘ^{(k)} and the co-adjacency matrix of X.
Homology and Cohomology Message Passing Scheme (HCMPS): We adapt a non-matrix notation for convenience. Let cₘ be a cell in a cell complex X. Denote by Bd(x) to the set of cells y of dimension k−1 such that yϵ∂(x), the boundary of x, such that x and y have compatible orientations. In the same manner, CoBd(x) denotes all cells of yϵX with hϵ∂(y). Let [symbol] (x) be Bd(x)∪CoBd(x), the Homology and Cohomolgy Message Passing Scheme (HCMPS) is given by

h_{c}_{^{m}}^{(k)}:=αₘ^{(k)}(h_{c}_{^{m}}^{(k-1)},E^{aϵI(x)}(ϕ_{m,d(a)}^{(k)}(h_{c}_{^{m}}^{(k-1)},hₐ^{(k-1)})))ϵ [symbol] ^{l}^{ₘ}^{^{k}} (4)

where h_{c}_{^{m}}^{(k)}ϵ [symbol] ^{l}^{ₘ}^{^{k}}, E is a permutation invariant differentiable function, αₘ^{(k)}, ϕₘ^{(k)} are trainable differentiable functions. In case both αₘ^{(k)}, ϕₘ^{(k)} are Multilayer Perceptron (MLP) and E the summation operation.

Note that implementation of the equations that describe cell complex network above can be done using the libraries described below. It suffices that the input include the adjacency, adjacency and boundary matrices of the cell complex Xₖ. These matrices are sparse matrices which can be computed efficiently using the packages that we developed.

Point Cloud CXN (PCXN)

The input for the PCXN net consists of the input point cloud data, the complex X, and the embeddings [symbol] where [symbol] ={H₀⁰, H₁⁰, H₂⁰}. Recall that H₁⁰, H₁⁰ and H₂⁰ are the data stored on the nodes, the edges and faces of complex X which are obtained from the 3D scanner data. The output of PCXN network will be denoted by PCXN(X, [symbol] ) and it consists of a set of the form PCXN(X, [symbol] )={ [symbol] ₙ, [symbol] ₑ, [symbol] _{f}} where [symbol] ₙ, [symbol] ₑ and [symbol] _{f} are the output embeddings on the nodes, edges and the faces of X. We next explain how to compute PCXN( [symbol] ). Precisely PCXN( [symbol] ) is obtained as follows:
1. Apply the equations (Eq. 2), (Eq. 3), and (Eq. 4). We choose the depth L for each one of them to be 3. We will denote the output data on the cell complex obtained by processing these three message passing schemes by AMPS( [symbol] ), CMPS( [symbol] ) and HCMP( [symbol] ).
2. The node feature obtained from the output of AMPS( [symbol] ), CMPS( [symbol] ) and HCMP( [symbol] ) are concatenated together into a single vector which we pass through a regular Multilayer Perceptron (MLP) for processing. At the end of this process, we have an embedding associated with every node in the input complex X. We repeat the same process for the edges and the faces in X as well.

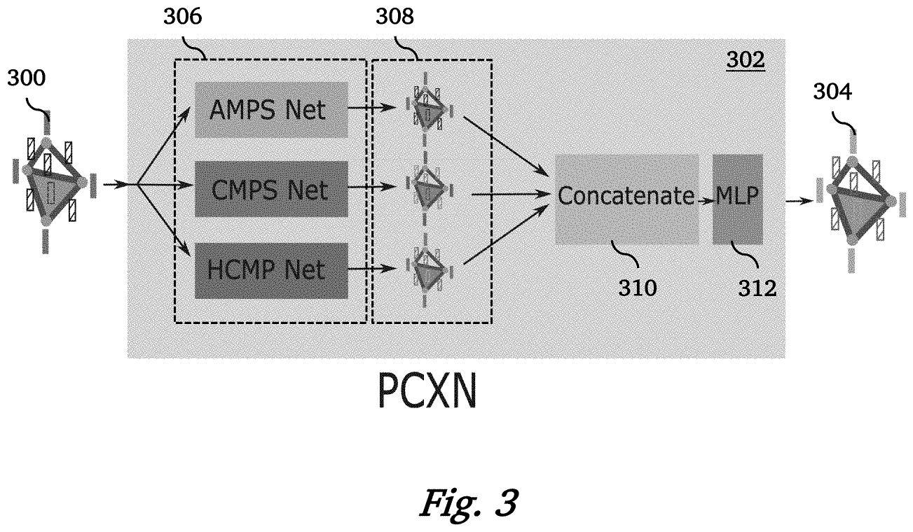

The architecture of the PCXN network is shown in FIG. 3. The network 302 takes as input the complex X 300 as well as the cell embeddings. The output 304 is a collection of embeddings stored on each cell in the complex X. Within the network 302 the input data 300 is passed through the geometric message passing network 306 we described above, which includes the AMPS, CMPS and the HCMP. For each cell, we then obtain three embeddings 308 from these three networks 306. We concatenated these embeddings in block 310 and then pass them through a MLP 312 for processing to produce the output 304.

### Point Cloud Segmentation Network

Each node in the complex X corresponds to the point obtained from input put cloud [symbol] . In in the segmentation stage, we like to segment the point cloud scene into meaningful objects, (e.g. cars, trees, chairs, etc). This is the purpose of the point cloud segmentation which we shall explain next.

The point cloud segmentation network, denoted by PCSN, takes as an input the clique complex X as well as the embeddings [symbol] of the cells in X. For each node vᵢ in X, the network PCSN outputs the class of the corresponding point pᵢ. The final output of PCSN is a node-wise label which can be then utilized to determine the segments.

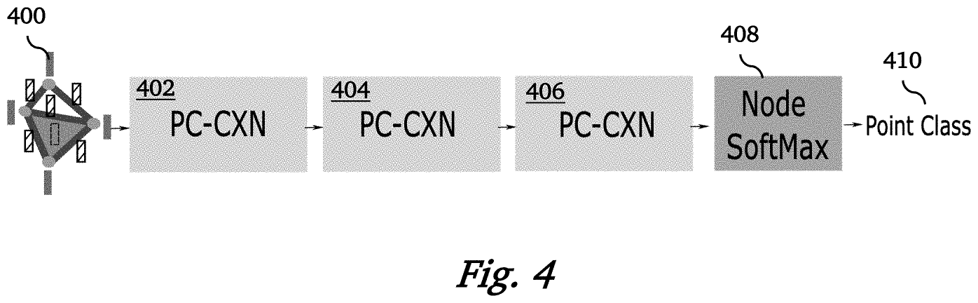

The present architecture of the PCSN is outlined in FIG. 4. First, the input data 400 is processed using three blocks of PCXN 402, 404, 406. By the end of this processing, we obtain a collection of embeddings for each cell in the input complex X. Each resulting node embedding is passed through a softmax layer 408, to obtain the final classification 410 of that particular node.

The first three layers 402, 404, 406 are PCXN blocks. The output of these layers is the embeddings stored on each cell in the complex X. To obtain the node-wise classification, the we utilize the embeddings [symbol] ₙ stored on the nodes of X and obtained from the PCXN blocks blocks and apply a softmax classification layer 408 for each node embedding in [symbol] ₙ. Here the softmax layer defined by the composition softmax=D∘Exp where Exp(x₁, . . . ,xₙ)=(exp(x₁), . . . , exp(xₙ)), and D is defined by D(x₁, . . . , xₙ)=(x₁/Σᵢ₌₁ⁿxᵢ, . . . , xₙ/Σᵢ₌₁ⁿxᵢ).

The network PCSN can be trained in an end-to-end fashion using classification cross-entropy classification loss.

### Point Cloud Classification Network

The present network can be also utilized for entire point cloud classification tasks. We call this mode the object recognition mode. Here, we describe the architecture of the point cloud classification CXN in detail.

The point cloud classification network PCN is similar to the point cloud segmentation network. Namely, a PCN consists of a compositing of multiple blocks of PCXN. After the PCXN we follow the process by a collapse net and finally a softmax layer to output the final classification of the input object. Next, we describe the collapse net.

### Collapse Net Architecture

The input of the collapse network is the complex X as well as the embeddings obtained from the outputs of the PCXN net. We will denote these outputs by [symbol] (X)={ [symbol] ₙ(X), [symbol] ₑ(X), [symbol] _{f}(X)}.

The idea of the collapse network is to collect all information stored in the embeddings [symbol] (X) and store them in a single vector hₓ. To this end, define the vector h_{X} is defined via

$${h}_{X} = {\sum }_{{z}_{m} ∈ 𝒪 ( X )} {w}_{m} ( 𝒪 ( X ) ; W ) {z}_{m} \qquad ( 5 )$$

where wₘ( [symbol] (X); W)ϵ [symbol] is a weight of the cell embedding zₘ that depends on [symbol] (X) and parametrized by Wϵ [symbol] ^{d×d} a trainable weight matrix. The weight wₘ is defined via

$${w}_{m} ( 𝒪 ( X ) ; W ) = σ ( {( {z}_{m} )}^{T} RELU ( W ( {\sum }_{{z}_{n} ∈ 𝒪 ( X )} {z}_{n} ) ) , \qquad ( 6 )$$

where

$$σ ( x ) = \frac{1}{1 + exp ( - x )} .$$

Finally h_{X} in passed through a softmax layer to obtain the final object classification label.

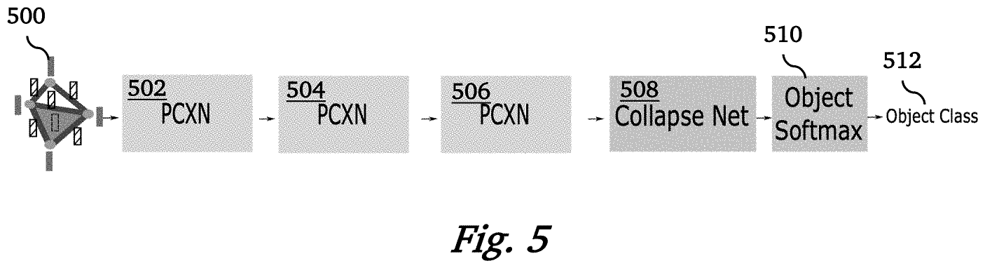

FIG. 5 shows the architecture of the point cloud classifications network. The input 500 of this network is a clique complex obtained as we described in the section above on constructing the clique complex from the point cloud. This input 500 is processed via a sequence of PCXN blocks 502, 504, 506. We then use a collapse net 508 to collapse all the information obtained from these embeddings to obtain a single vector embedding h_{X} that represents the complex X. This vector is than passed to a softmax classification layer 510 to obtain the final object classification label 512.

The network described above can be trained also in an end-to-end fashion using cross entropy classification loss.

### Implementation, Training, and Deployment

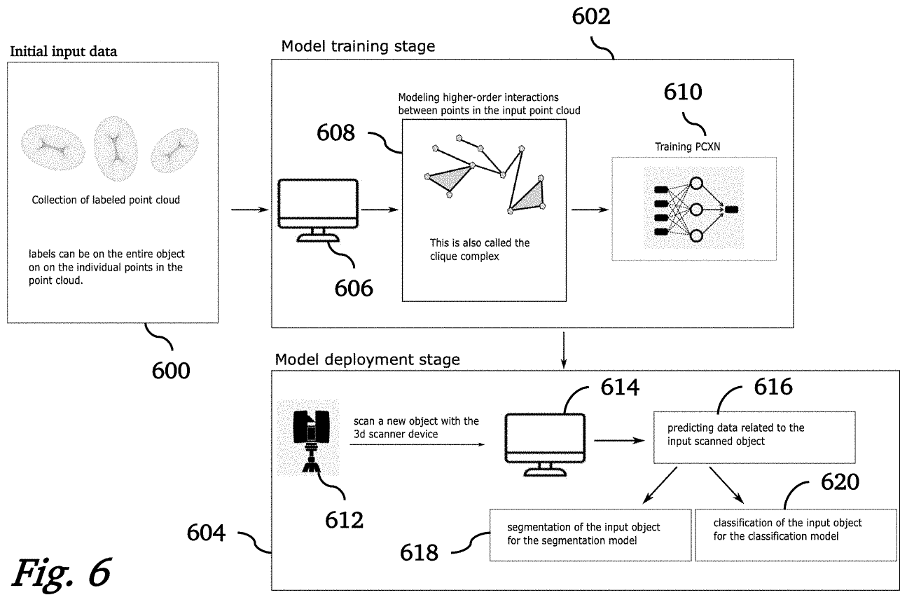

FIG. 6 is a schematic diagram illustrating an overview of the processing pipeline for the deployment of the present technology. Training point cloud data 600 with labels is input to a model training stage 602 which results in a trained PCXN. Specifically, a processor 606 generates a clique complex 608 from each point cloud in the data. The PCXN is then trained using the clique complexes and associated labels. This trained PCXN is then used in a model deployment stage 604 to perform object recognition and/or segmentation of point cloud data. Specifically, a scanner device 612 generates point cloud data which is input to a processor 614 that uses the trained PCXN 610 to predict data 616 related to the object or scene scanned by the scanner device 612. This predicted data 616 may be segmentation data 618 or classification data 620.

### Specialized Python Libraries Built to Support the Technology

To develop the technology presented herein, we have completely and comprehensively implemented two python libraries that are tailored towards building and developing our application quickly and efficiently. Specifically, the first library is developed to build higher order networks such as cell complexes, simplicial complex, hypergraph, and combinatorial complexes while the second library is developed to train models supported on these higher order networks.

Our two libraries support the following features:
1. Building a cell complex with arbitrary dimension. In particular, our higher order complexes library support modeling the simplicial/cell complex nodes as point clouds and modeling higher order interactions between the point clouds as higher order relations between these points.
2. After building the complex, our libraries support building sparse and massive adjacency and the incidence matrices used to train the model as specified in Eq. 4 and Eq. 5.
3. Beyond modeling points in the point cloud in terms of the elements of the cell/simplicial complex, our libraries support attaching any type of data to various parts of the cell/simplicial complex to represent the data acquired from the 3D acquisition devices. This data can be vector data obtained during various stages of training/testing/deployment, or any other 3D acquisition device data one may wish to attach to any stage of training/testing/deployment. Our libraries also support the manipulation of this data, whenever applicable, with other popular python libraries such as Numpy, Scipy, TensorFlow and Pytorch. This facilitate fast and practical implementation and deployment of the present technology.
4. After building the complex and attaching various data elements to various elements of this complex, our library supports building and training any higher order model; in particular, it supports building a model as specified in Eq. 4 and Eq. 5.

To facilitate fast computation over massive relational data we exploit sparse matrices capabilities available in PyTorch Geometric (Fey et al., Fast graph representation learning with pytorch geometric, arXiv preprint arXiv:1903.02428 (2019)). Note that we only exploit this feature from PyTorch Geometric, but the rest of the library is novel and contains new functions that allow creating higher order networks efficiently and modeling higher order relationships.

### Description of the Training Datasets

### Segmentation Model Dataset

The segmentation model dataset consists of a point cloud data [symbol] =p₁, . . . , pₙ, where each point pᵢϵ [symbol] is associated with a unique label that represents the class of that point (e.g. a tree, a car, face, etc). Several publicly available datasets (e.g., SCALE.COM, Pandaset) that fit this description can be used.

### Classification Model Dataset

The classification model dataset consists of a collection of point cloud datasets [symbol] _{N}, . . . , [symbol] _{N}, where each [symbol] ᵢ is associated with a label that represents the object. The same datasets used for segmentation can be used for classification. For instance, the PandaSet data available by Scale AI can be used towards this goal.

Note that both segmentation and classification tasks have the same input with different levels of annotation; point-based annotation for segmentation and object-based annotation (e.g., car, tree) for classification.

### Training Stage

To train CXNs with our libraries, we specify the adjacency matrices obtained from the cell complex X= [symbol] ₖ( [symbol] ) as well as the initial vectors specified by the list of points [symbol] obtained from the 3D acquisition device. The adjacency matrices can be computed using our packages and libraries that we specified above. After specifying the input, the present technology is then trained using standard stochastic gradient descent similar to a regular graph neural networks (Li et al., Training graph neural networks with 1000 layers, arXiv preprint arXiv:2106.07476 (2021)). Finally, the hyperparameters of the training procedure are specified using Bayesian optimization during training (Springenberg et al., Bayesian optimization with robust bayesian neural networks, Advances in neural information processing systems 29 (2016), 4134-4142).

As for the hardware specification, it is recommended to utilize the new “AI accelerators” such as Google's Tensor Processing Units (TPU) or Intel's Nervana Neural Network Processor for training. Such solutions allow for massive scale computing capacity and are well-suited for sparse matrix computation, which are needed for our training.

### Deployment of Cxn in Practice.

When working with neural networks in general we have two phases: a training phase and a deployment phase. In our case, the trained CXN can be utilized to infer results for segmentation or recognition of a new point cloud data. It is worth mentioning that cell complex nets, while relying on higher order interaction to provide the prediction, can use sparse matrices to store the data of the complexes, and sparse matrices are fast and reliable in practical applications (Tewarson et al., Sparse matrices, Vol. 69, Academic Press New York, 1973).

### Testing and Validation

The inventors have built this architecture using our first library described above, and trained this architecture as described above using our second library described above. The present technology achieved predictive accuracy of 99.5% and 98.4% for segmentation and classification, respectively. Also, our results showed that the present technology outperformed similar networks in the literature. It is worth mentioning that our method uses a significantly lower number of epochs to train (30 epochs) making it easy to update and deploy in practice.

1. A method for object recognition from point cloud data, the method comprising:
(a) acquiring point cloud data using a 3D data acquisition device;
wherein the point cloud data is irregular data;
(b) constructing a nearest neighbor graph from the point cloud data;
(c) constructing a cell complex from the nearest neighbor graph;
wherein the cell complex includes k-cells, where k>2;
(d) processing the cell complex by a cell complex neural network (CXN) to produce a point cloud segmentation or a point cloud classification;
wherein the CXN includes k-cells, where k>2;
wherein the processing by the CXN comprises using geometric message passing schemes to implement deep learning protocol in the CXN.

2. The method of claim 1 wherein the point cloud segmentation comprises an object classification label for each point in the point cloud.

3. The method of claim 1 wherein the point cloud classification comprises a classification label identifying an object in the point cloud.

4. The method of claim 1 wherein the 3D data acquisition device is a LiDAR scanner.

5. The method of claim 1 wherein the irregular data does not have a predefined size or uniform sampling.

6. The method of claim 1 wherein constructing the cell complex comprises constructing a clique complex.

7. The method of claim 1 wherein the message passing schemes include adjacency message passing schemes, co-adjacency message passing schemes, or homology and co-homology message passing schemes.

8. The method of claim 1 wherein the CXN is modeled and computed using sparse matrices.
